(19) United States
(12) Patent Application Publication
(10) Pub. No.: US 2026/0359962 A1
(43) Pub. Date: Nov. 12, 2026

(54) MACHINE LEARNING BASED TEXT-TO-IMAGE EVALUATION

(71) Applicant: SAMSUNG ELECTRONICS CO., LTD., Suwon-si (KR)

(72) Inventors: Yi WEI, Sunnyvale, CA (US); Suren KUMAR, Seattle, WA (US); Luowei ZHOU, Bellevue, WA (US)

(73) Assignee: SAMSUNG ELECTRONICS CO., LTD., Suwon-si (KR)

(21) Appl. No.: 19/535,489

(22) Filed: Feb. 10, 2026

Related U.S. Application Data
(60) Provisional application No. 63/802,911, filed on May 9, 2025.

(51) Int. Cl. G06T 7/00; G06T 11/00

(52) U.S. Cl. CPC G06T 7/0002; G06T 11/00; G06T 2207/30168

(57) ABSTRACT

A method for evaluating images generated by a Text-to-Image (T2I) model is provided. The method includes generating, using the T2I model; a first image based on a first text prompt, generating, using an encoder, an image embedding based on the first image; generating, using a Multi-Modal Large Language Model (MLLM), a first type token and a second type token based on the first text prompt, the first image, and a task instruction; deriving, using a first decoder, an evaluation score of the first image based on the first type token; obtaining, using a second decoder, an artifact region information based on the second type token and the image embedding; and providing the evaluation score and the artifact region information.

### CROSS-REFERENCE TO RELATED APPLICATION

This application claims priority to and is based on U.S. Provisional Patent Application No. 63/802,911, filed on May 09, 2025, the disclosure of which is incorporated herein in its entirety by reference.

### BACKGROUND

### 1. Field

Embodiments of the present disclosure relate to machine-learning based text-to-image (T2I) evaluation, and more particularly, to an electronic device that uses a machine learning model to evaluate images generated by a Text-to-Image (T2I) model, and a method therefor.

### 2. Description of Related Art

Text-to-image (T2I) models may be trained to generate images from written descriptions. For example, a user may send prompts to a T2I model such that the T2I model can generate images corresponding to the prompt. These models learn from large datasets of image-text pairs to establish associations between textual descriptions and visual representations. However, the accuracy of those T2I models may be far from perfect, with significant visual artifacts and text-image misalignment issues in generated images. Visual artifacts may include distortions, inconsistencies, and unrealistic elements, while misalignment issues may include generated images failing to accurately reflect attributes, objects, or spatial relationships specified in the prompt. Additionally, T2I models may not be aligned with user preferences, resulting in generated images that do not comply with or remain inconsistent with the prompts received from users. The quality of images generated by T2I models may be improved to not only enhance user experience but also to save computing resources (e.g., processing power, memory) wasted as a result of deploying inaccurate T2I models.

### SUMMARY

According to an aspect of the disclosure, a method for evaluating images generated by a Text-to-Image (T2I) model may include generating, using the T2I model, a first image based on a first text prompt; generating, using an encoder, an image embedding based on the first image; generating, using a Multi-Modal Large Language Model (MLLM), a first type token and a second type token based on the first text prompt, the first image, and a task instruction; deriving, using a first decoder, an evaluation score of the first image based on the first type token; obtaining, using a second decoder, an artifact region information based on the second type token and the image embedding; and providing the evaluation score and the artifact region information.

The method may further include generating a reward instruction based on the evaluation score and the artifact region information; and fine-tuning the T2I model based on the reward instruction, the first text prompt, and the first image. The at least one loss function to fine-tune the T2I model may be adjusted based on at least one of the evaluation score or the artifact region information.

The method of fine-tuning of the T2I model may be based on a determination that the T2I model met one or more criteria corresponding to an accuracy of the T2I model. The determination may be made based on at least one of user input different from the first text prompt, the evaluation score, or the artifact region information.

The method may further include generating, using the fine-tuned T2I model, a second image based on a second text prompt and a score that correspond to the second image.

The second image may include a plurality of pixels replaced in areas identified as artifacts by the artifact region information.

The MLLM may be fine-tuned based on Low-Rank Adaptation (LoRA).

The task instruction may indicate a type of the evaluation score to be generated.

The type of the evaluation score may include at least one of text-image alignment score generation, aesthetic quality score generation, overall quality score generation, or plausibility score generation.

The artifact region information may be indicated by one or more binary masks.

The MLLM, the first decoder, and the second decoder may be trained based on at least one of auto-regressive cross-entropy loss, mean squared error (MSE) loss, binary cross-entropy (BCE) loss, or DICE loss.

According to an aspect of the disclosure, an electronic device may include at least one processor and memory storing at least one instruction. The at least one instruction, when executed by the at least one processor individually or collectively, may cause the electronic device to generate, using the T2I model, a first image based on a first text prompt; generate, using an encoder, an image embedding based on the first image; generate, using a Multi-Modal Large Language Model (MLLM), a first type token and a second type token based on the first text prompt, the first image, and a task instruction; derive, using a first decoder, an evaluation score of the first image based on the first type token; obtain, using a second decoder, an artifact region information based on the second type token and the image embedding; and provide the evaluation score and the artifact region information.

The at least one instruction, when executed by the at least one processor individually or collectively, may further cause the electronic device to generate a reward instruction based on the evaluation score and the artifact region information; and fine-tune the T2I model based on the reward instruction, the first text prompt, and the first image. The at least one loss function to fine-tune the T2I model may be adjusted based on at least one of the evaluation score or the artifact region information.

The at least one instruction, when executed by the at least one processor individually or collectively, may further cause the electronic device to fine-tune of the T2I model based on a determination that the T2I model met one or more criteria corresponding to an accuracy of the T2I model. The determination may be made based on at least one of user input different from the first text prompt, the evaluation score, or the artifact region information.

The at least one instruction, when executed by the at least one processor individually or collectively, may further cause the electronic device to generate, using the fine-tuned T2I model, a second image based on a second text prompt and a score that correspond to the second image.

The second image may include a plurality of pixels replaced in areas identified as artifacts by the artifact region information.

The MLLM may be fine-tuned based on Low-Rank Adaptation (LoRA).

The task instruction may indicate a type of the evaluation score to be generated. The type of the evaluation score may include at least one of text-image alignment score generation, aesthetic quality score generation, overall quality score generation, or plausibility score generation.

The artifact region information may be indicated by one or more binary masks.

The MLLM, the first decoder, and the second decoder may be trained based on at least one of auto-regressive cross-entropy loss, mean squared error (MSE) loss, binary cross-entropy (BCE) loss, or DICE loss.

According to an aspect of the disclosure, A non-transitory computer-readable storage medium having stored thereon instructions that, when executed by at least one processor of an electronic device individually or collectively, may cause the electronic device to generate, using the T2I model, a first image based on a first text prompt; generate, using an encoder, an image embedding based on the first image; generate, using a Multi-Modal Large Language Model (MLLM), a first type token and a second type token based on the first text prompt, the first image, and a task instruction; derive, using a first decoder, an evaluation score of the first image based on the first type token;7 obtain, using a second decoder, an artifact region information based on the second type token and the image embedding; and provide the evaluation score and the artifact region information.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram illustrating training T2I evaluation models to improve T2I models, according to one or more embodiments of the present disclosure;

FIG. 2 is a diagram illustrating an electronic device for T2I evaluation, according to one or more embodiments of the present disclosure;

FIG. 3 is a diagram illustrating a T2I evaluation model, according to one or more embodiments of the present disclosure;

FIG. 4 is a diagram illustrating a T2I model improved based on evaluations generated by the T2I evaluation model, according to one or more embodiments of the present disclosure;

FIG. 5 is another diagram illustrating the T2I evaluation model, according to one or more embodiments of the present disclosure;

FIG. 6 is a flowchart illustrating a process for training the T2I evaluation model to improve T2I models, according to one or more embodiments of the present disclosure;

FIG. 7 is a flowchart illustrating a process for generating evaluations using the T2I evaluation model, according to one or more embodiments of the present disclosure;

FIG. 8 is a flowchart illustrating a process for evaluating and fine-tuning T2I models using T2I evaluation models, according to one or more embodiments of the present disclosure; and

FIG. 9 illustrates examples of images with and without masks that indicate artifact regions, according to one or more embodiments of the present disclosure.

### DETAILED DESCRIPTION

One or more embodiments of the present disclosure will be described in detail with reference to the accompanying drawings. Specific configurations and details are provided to ensure thorough understanding of the implementation techniques. However, these techniques may be practiced in different configurations without such specifics. Well-known features may be omitted or simplified to avoid obscuring the described techniques.

Other variations are within the spirit of the present disclosure. While the disclosed techniques are susceptible to various modifications and alternative constructions, certain illustrated embodiments are shown in the drawings and described above in detail. However, there is no intention to limit the disclosure to the specific forms disclosed. Rather, the intention is to cover all modifications, alternative constructions, and equivalents falling within the spirit and scope of the disclosure as defined in the appended claims.

Text-to-image (T2I) models may be deployed to create visual content based on written inputs. Users provide descriptive text to these systems, which then produce corresponding images. However, T2I models may produce imperfect results, resulting in notable flaws in image quality and failing to accurately match the text input. Quality issues may include warped features, internal contradictions, and implausible components. Also, generated images may not properly represent the characteristics, items, or positional arrangements described in the prompt provided by the users.

There may be difficulties in improving T2I models. For example, collecting a large amount of high-quality human preference data to further train the T2I models may require significant resources. Additionally, evaluation metrics such as CLIPScore, HP Score, and Aesthetic Score, each generated by different models, may not alone be sufficient indicators of quality of images generated by T2I models. As a result, correct assessment and further training of T2I models may be difficult, and a large amount of computing resources (e.g., processing power, memory, network bandwidth) may be wasted by deploying T2I models that do not meet user preferences. Additional delays in using the T2I models may be introduced by repetitive interactions between the user and the T2I models, as the models fail to produce the correct result in a single attempt, leading to increased data transmission that strains low bandwidth connections.

According to one or more embodiments, a T2I evaluation model (e.g., T2I evaluation model 104) may be provided to improve the T2I models (e.g., second pre-trained T2I model 106). The T2I evaluation model may be based on a Multi-modal Large Language Model (MLLM) (e.g., pre-trained portion 511) equipped with unified prediction heads. The T2I evaluation model may receive a task-specific prompt so that a corresponding decoder (e.g., score decoder 515, mask decoder 514) within the T2I evaluation model may be activated automatically. For example, the task may include generating a score (e.g., evaluation score 324) for at least one of plausibility/artifacts, text-image alignment, aesthetic quality, overall quality, etc. Also, the task may further include generating an artifact map (e.g., artifact mask 326) that may serve as a visual explanation for image quality. The artifact map may be a segmentation masks that localizes visual artifacts.

According to one or more embodiments, the T2I evaluation model may receive images, text prompt, and task instructions (e.g., type of score, masks) as input and may generate scores or mask outputs respectively according to the query prompt and the task instructions. Two new tokens such as <SCORE> and <SEG> may be added to the original MLLM library. The MLLM within the T2I evaluation model may generate an output sequence with the new tokens based on the text prompt and its corresponding image. The output sequence may be represented as embedding vectors. The embedding vectors may be input to the corresponding decoders so that the decoders may generate a score that corresponds to the task and/or masks that indicate the artifacts within the input image. During training of the T2I evaluation model, the MLLM backbone may be fine-tuned (e.g., with Low-Rank Adaptation (LoRA)) while the decoders are fully trained. The trained T2I evaluation models may be deployed for evaluation of the deployed T2I models and also to generate reward instructions to further train the T2I models that fell below the threshold (e.g., requiring additional training). The T2I models may be then further trained based on the generated reward instructions such that the T2I models are capable of generating images that matches a particular score (e.g., score 406). Different scores and the artifact maps may be used with various loss functions such that the T2I models are trained to generate images with improved quality. Also, the scores may also be used to reward to the T2I models if they generate images that match the expected quality. The improved T2I models may also be evaluated based on the trained T2I evaluation models to determine whether the further trained T2I models meet the criteria to be deployed. As a result, T2I models with improved accuracy may be deployed to improve user experience.

According to one or more embodiments, training and deploying the T2I evaluation model may provide various advantages and improvements in computer technology and the technical field. For example, less resources may be used to generate a large amount of data to further train the T2I evaluation models, as the T2I evaluation model may generate scores across different aspects solely relying on the task prompt. Also, the T2I evaluation models may cover a wide variety of evaluation aspects such as image quality and unnatural image regions identification. Additionally, the T2I evaluation model may be easily adapted to new evaluation tasks (e.g., new metrics that measure quality of the images generated by the T2I models) with less amount of data. Moreover, using the T2I evaluation model to further train T2I models may improve the accuracy of outputs generated by the improved T2I models, resulting in less computing resource usage (e.g., processing power, memory, network constraints) when deploying the improved T2I models.

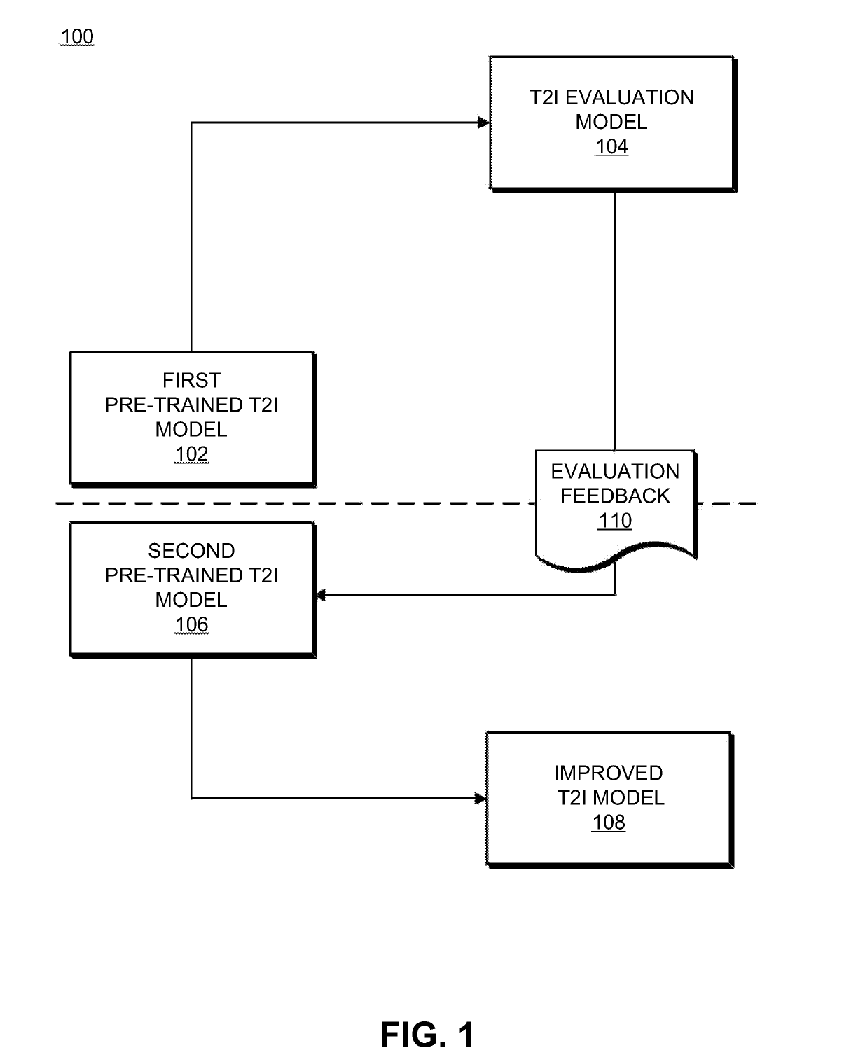

FIG. 1 is a diagram illustrating training T2I evaluation models to improve T2I models, according to one or more embodiments of the present disclosure. System 100 may include a first pre-trained T2I model 102, T2I evaluation model 104, second pre-trained T2I model 106, and improved T2I model 108.

Throughout the present disclosure, various “models” may refer to artificial intelligence (AI) models, machine learning models, and neural networks. The models may include artificial neural network (ANN), feedforward neural network (FNN), multilayer perceptron (MLP), convolutional neural network (CNN), recurrent neural network (RNN), long short-term memory (LSTM), transformers (e.g., vision transformer (ViT), graph neural network (GNN), residual neural network, generative adversarial network (GAN), or any combination thereof. The models may further include linear regression models, tree-based models, nearest neighbor models, clustering models), or any combination thereof.

T2I models (e.g., first pre-trained T2I model 102, second pre-tT2I>2I model 106, improved T2I model 108) may refer to a model that receives at least text (e.g., a query or a text prompt) as an input and outputs images corresponding to the text. For example, if the text instructs the model to generate an image depicting a cat and a dog, the model generates an image depicting both.

The first pre-trained T2I model 102 may be a basis for training the T2I evaluation model 104. The pre-trained T2I model 102 may include an MLLM. MLLM may refer to a model (e.g., large language models (LLM)) that generates information across multiple types of data modalities (e.g., text, images, audio, video), by integrating these diverse inputs into a unified representation that enables the model to perform tasks requiring cross-modal reasoning and generation. The pre-trained T2I model 102 may include a vision LLM.

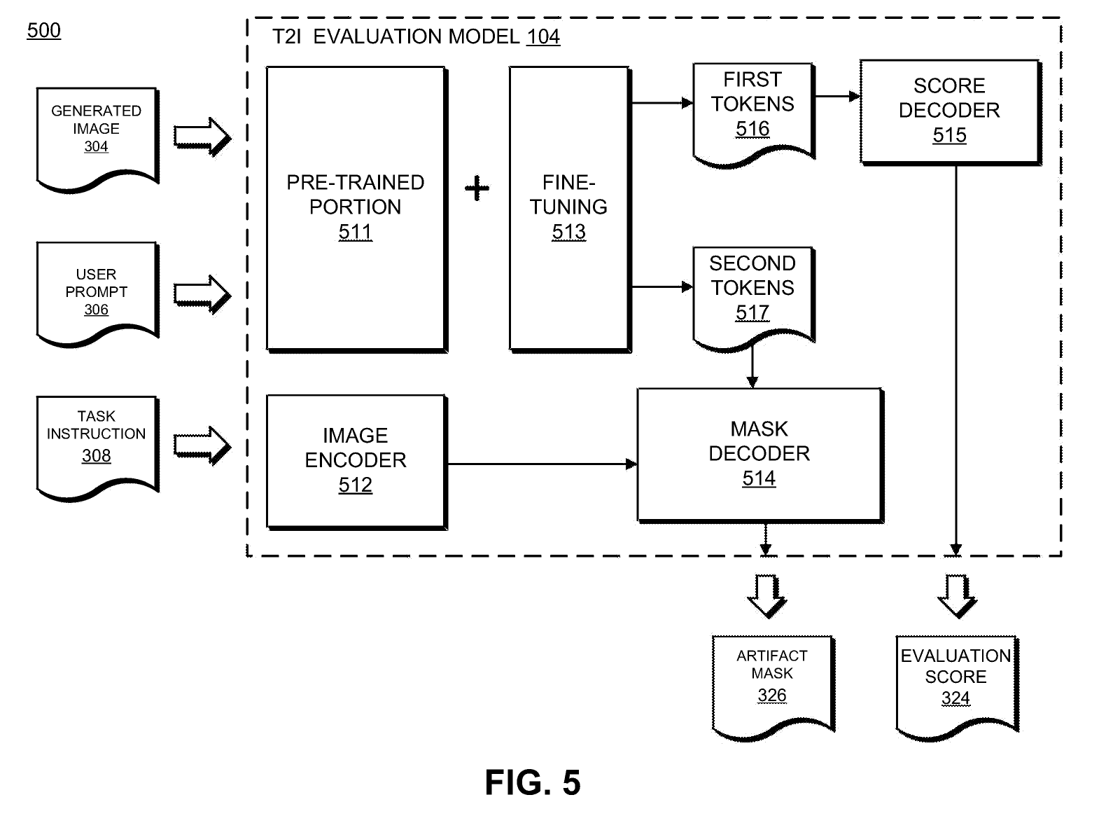

Training a model may refer to adjusting the parameters of a machine learning algorithm using data so that the model can learn patterns and make accurate predictions or decisions. Examples of training may include at least one of supervised learning, unsupervised learning, semi-supervised learning, reinforcement learning, transfer learning, self-supervised learning, or any combination thereof. Transfer learning may refer to using knowledge gained from training a model on one task or dataset and applying it to a different but related task, requiring less data and computational resources than training from scratch. Examples of transfer learning may include at least one of full fine-tuning, layer-wise fine-tuning, parameter efficient fine-tuning, or any combination thereof. Training the first pre-trained T2I model 102 to generate T2I evaluation model 104 may be further described in conjunction with FIG. 5. When a model is trained or fine-tuned within one or more embodiments of the present disclosure, at least one of the aforementioned techniques may be used.

The T2I evaluation model 104 may be trained to generate evaluation feedback 110 which may include various scores and segmentation masks that indicate artifacts or any other abnormalities within images generated by the T2I models (e.g., a second pre-trained T2I model 106). The evaluation feedback 110 may include a set of evaluation scores 324 and artifact masks 326, which are further described herein. The T2I evaluation model 104 may receive the user text prompt (e.g., user prompt 306), the generated image from the T2I models (e.g., generated image 304), and task instructions (e.g., task instruction 308) that specify the evaluation perspective and criteria. The T2I evaluation model 104 may include an MLLM backbone (e.g., pre-trained portion 511) connected by two decoder heads (e.g., score decoder 515, mask decoder 514) working as a score predictor and binary mask predictor. The two decoder heads may receive token embedding (e.g., first token 516, second token 517) from the MLLM backbone and generate either a numerical score or a binary mask, or both depending on the task instructions.

The evaluation feedback 110 may indicate the quality of images generated by the T2I models. Also, the evaluation feedback 110 may be used to determine whether the second pre-trained T2I model 106 needs fine-tuning. The evaluation feedback 110 may be used to generate a data set to further train or fine-tune the second pre-trained T2I model 106. For example, the evaluation feedback 110 may include various types of scores that correspond to generated images from the second pre-trained T2I model 106 that can be used as image-score pairs to fine-tune the second pre-trained T2I model 106. Also, the scores can be used to filter which images are to be used as a training data set.

According to one or more embodiments, the second pre-trained T2I model 106 may be fine-tuned to generate an improved T2I model 108 based on the evaluation feedback 110. For example, the evaluation feedback 110 may be appended to the text prompt (that is used by the second pre-trained T2I model 106) to generate the corresponding images as a reward-condition. In some examples, the scores may be appended to the text prompt as “the image quality is [SCORE]” so that the improved T2I model 108, when trained, generates images that align with the score. Also, the evaluation reward loss may be added as auxiliary training loss for the second pre-trained T2I model 106 to generate the improved T2I model 108. Training and deployment of the improved T2I model 108 will be further described herein.

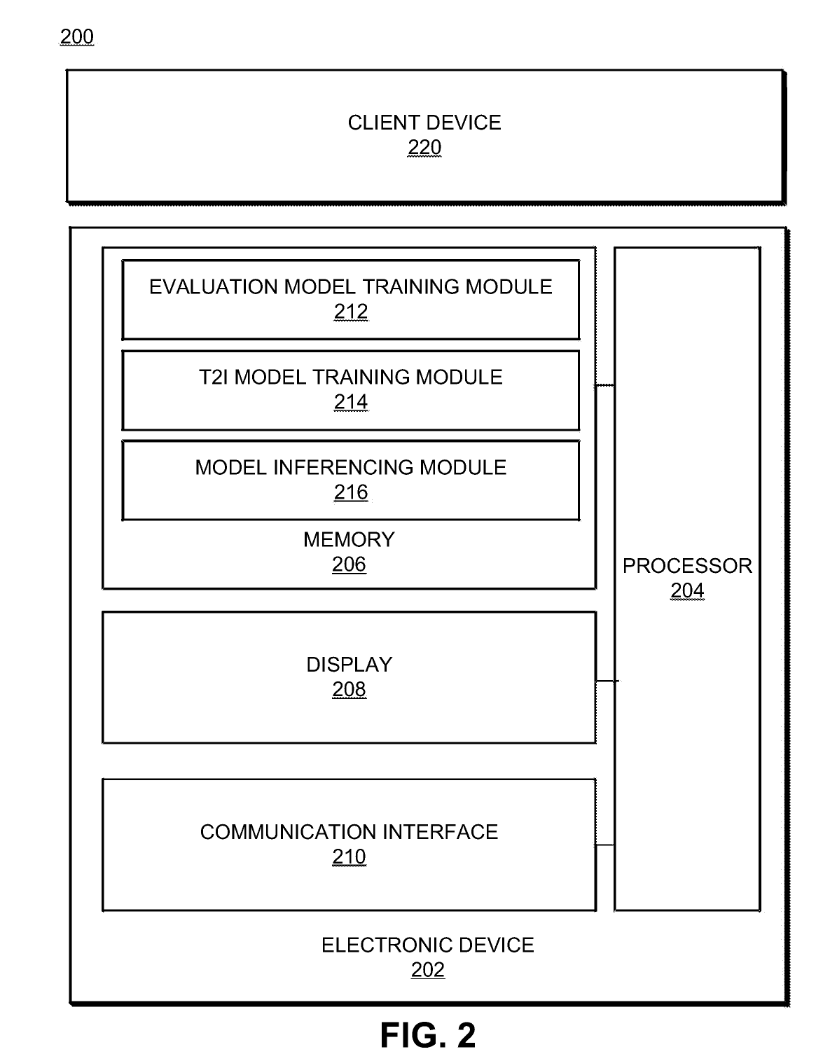

FIG. 2 is a diagram illustrating an electronic device for T2I evaluation, according to one or more embodiments of the present disclosure. According to one or more embodiments, system 200 may include an electronic device 202 and client device 220. The electronic device 202 may include a processor 204, memory 206, display 208, and communication interface 210.

The processor 204 may include at least one of a central processing unit (CPU), a graphics processing unit (GPU), a digital signal processor (DSP), an application-specific integrated circuit (ASIC), a field-programmable gate array (FPGA), a microcontroller, a neural processing unit (NPU), a tensor processing unit (TPU), or any combination thereof. The processor 204 may include two or more processors. The processor 204 may perform one or more instructions stored in memory 206 to cause the electronic device 202 to perform various operations described herein.

The memory 206 may include at least one of random access memory (RAM), dynamic RAM (DRAM), static (RAM), high bandwidth memory (HBM), cache memory, read-only memory (ROM), flash memory, solid-state drive (SSD), hard disk drive (HDD), SD card), or any combination thereof. The electronic device 202 may also communicate with cloud storage or any other network-attached storage (NAS) via the communication interface 210 to store and retrieve data (e.g., machine learning models, training data, inference results, model performance).

The memory 206 may store various model parameters or hyperparameters to deploy and/or train the models. The memory 206 may store reward instructions generated by the T2I evaluation models or any other training data sets (e.g., a combination of prompt, score, task, artifact map) usable to train the T2I models and/or T2I evaluation models. The memory 206 may also keep track of performance data related to the T2I models.

The memory 206 may store evaluation model training module 212, T2I model training module 214, and model inferencing module 216, and the processor 204 may execute one or more instructions of evaluation model training module 212, T2I model training module 214, and model inferencing module 216 to perform the functionality thereof.

According to one or more embodiments, evaluation model training module 212 may refer to a module that performs training of the T2I evaluation modules (e.g., T2I evaluation model 104) described herein. As further described in conjunction with FIG. 5, T2I evaluation models may include trainable portions (e.g., fine-tuning 513, mask decoder 514, score decoder 515) and portions where the weights are frozen (e.g., pre-trained portion 511, image encoder 512). For each of the trainable portions, evaluation model training module 212 may use different loss functions.

For example, the loss for the pre-trained portion of the T2I evaluation models may include auto-regressive cross-entropy loss so that the MLLM backbone of the T2I evaluation models generate target text outputs with special tokens. The auto-regressive cross-entropy loss may refer to a loss function where the model predicts the next token in a sequence based on all previous tokens, and the loss may measure how far the model’s predicted probability distribution is from the actual correct token at each position. The loss may be computed by summing or averaging these individual token prediction errors across the entire sequence, pushing the model to assign higher probabilities to the correct next token at each step.

In another example, the loss for the decoder that generates the scores may be trained using the mean squared error (MSE) loss between the score predictions and target values. MSE loss may refer to a loss function that computes the average of the squared differences between the model’s predicted values and the actual target values across all data points. The loss may be calculated by summing the squared errors for each prediction-target pair and dividing by the number of samples so that the model minimizes the magnitude of its prediction errors.

Also, the loss for the decoder that generates the masks may be trained using a combination of per-pixel binary cross-entropy (BCE) loss and DICE loss. Per-pixel BCE loss may refer to a loss function that computes the cross-entropy between the model’s predicted probability and the ground truth binary label independently at each pixel location in an image. The loss may be calculated by averaging these individual pixel-level binary cross-entropy values across all pixels such that the model correctly classifies each pixel as belonging to one of two classes. DICE loss may refer to a loss function that measures the overlap between the model’s predicted segmentation and the ground truth segmentation by computing one minus the DICE coefficient, where the DICE coefficient is calculated as twice the intersection divided by the sum of the predicted and ground truth areas. The loss may be computed by setting the predicted probabilities and ground truth labels as soft sets to maximize the spatial overlap between predicted and target regions.

The total training loss for the T2I evaluation models may be formulated as a weighted sum of the first loss, the second loss, and the third loss. For example, the total training loss of the T2I evaluation model may be ℒ = λtext * ℒtext + λscore * ℒscore + λseg * ℒ seg, where λtext, λscore, and λseg may refer to weights of each loss and ℒtext, ℒscore, ℒ seg may refer to the loss for the MLLM backbone, the loss for the decoder that generates scores, and the loss for the decoder that generates masks, respectively.

According to one or more embodiments, T2I model training module 214 may refer to a module that performs training of the T2I models (e.g., second pre-trained T2I model 106) described herein based on training data generated by at least the T2I evaluation models.

The T2I model training module 214 may deploy the T2I evaluation model 104 to determine whether T2I models need fine-tuning or any other training. If it is determined that the one or more T2I models need fine-tuning or any other training, the T2I model training module 214 may deploy the T2I evaluation model 104 to generate large-scale human-quality evaluation scores for training data pairs, where the pairs can be used as reward signal to fine-tune the T2I models. The T2I training module 214 may filter out low-quality image-text pairs for T2I model training. T2I model training module 214 may receive additional training data not necessarily generated by the T2I evaluation model 104 to train the T2I models.

The training data generated by the T2I model training module 214 may be used to train the T2I models to generate an imT2I>2I model (e.g., improved T2I model 108) so that the improved T2I model may receive user prompt (e.g., user prompt 404) and score (e.g., score 406) as inputs and output images that correspond to the score. The improved T2I model may receive different types of scores (e.g., text-image alignment, overall quality, visual quality) and generate images corresponding to both the type and the magnitude of each score.

The T2I model training module 214 may use the scores within the reward signals so that high-scoring images shape the model more strongly. For example, when computing a denoising loss to fine-tune the T2I models, the scores may serve as weights to the loss such that images with higher scores may highly contribute to changing the parameters of the T2I models.

Also, the T2I model training module 214 may use the scores within the reward signals so that the improved T2I model may receive the scores, prompt, and the generated data as inputs and generate images that correspond to the scores.

The T2I model training module 214 may use the masks that indicate the artifacts within the reward signals to train the T2I model such that the improved T2I model does not generate those artifacts when generating the image with the same prompt. The losses may be tuned so that the improved T2I model does not generate artifacts. For example, the losses for mask regions may be different for the losses for other regions when computing the total loss for fine tuning the T2I model. The losses corresponding to the mask regions may be zeroed out or the losses for the mask regions may be inverted or be an adversarial loss.

According to one or more embodiments, model inferencing module 216 may refer to a module that deploys trained models, such as the T2I evaluation models and T2I models. The model inferencing module 216 may deploy the T2I evaluation models described herein so that the T2I evaluation models may evaluate, either in real time or based on one or more triggers, other T2I models that are also deployed by the model inferencing module 216.

In some examples, model inferencing module 216 may receive triggers such as user feedback indicating that the image quality of the deployed T2I models do not meet the expectation of the user. The model inferencing module 216 may evaluate the target T2I model by receiving historical data that includes the prompt and image pair and also run the model inferencing module 216 multiple times with different combinations of pairs and tasks to evaluate the T2I models from multiple perspectives. Model inferencing module 216 may perform an evaluation based on a weighted sum of different scores. Additionally, model inferencing module 216 may check the overall health of the deployed models that include T2I models and T2I evaluation models.

The communication interface 210 may enable the electronic device 202 to communicate with external devices (e.g., client device 220), networks, or any other systems. The communication interface 210 may include at least one of a wired interface, a wireless interface, or any combination thereof.

The wired interface may include at least one of an Ethernet interface, a Universal Serial Bus (USB) interface, a High-Definition Multimedia Interface (HDMI), a Thunderbolt interface, a Serial Peripheral Interface (SPI), an Inter-Integrated Circuit (I2C) interface, a Universal Asynchronous Receiver-Transmitter (UART), or any combination thereof.

The wireless interface may include at least one of a Wi-Fi interface, a Bluetooth interface, a Near Field Communication (NFC) interface, a cellular interface (e.g., 3G, 4G, LTE, 5G NR), a satellite communication interface, an infrared (IR) interface, or any combination thereof.

The display 208 may be configured to present visual information to a user. The display 208 may include at least one of a liquid crystal display (LCD), a light-emitting diode (LED) display, an organic light-emitting diode (OLED) display, an active-matrix organic light-emitting diode (AMOLED) display, a micro-LED display, a mini-LED display, a quantum dot display (QLED), an electronic paper display (e-paper), a thin-film transistor (TFT) display, a plasma display, a cathode ray tube (CRT) display, or any combination thereof.

The display 208 may be configured to display at least one of text, images, graphics, video, user interface elements, notifications, or any combination thereof. The display 208 may include a flexible display, a foldable display, a rollable display, or a curved display. The display 208 may be used to output various images and artifact maps generated by the T2I models and the T2I evaluation models.

The display 208 may further include a touchscreen interface configured to receive user input via at least one of a capacitive touch sensor, a resistive touch sensor, an infrared touch sensor, or any combination thereof.

According to one or more embodiments, electronic device 202 may receive, via the communication interface 210, user inputs from the client device 220. For example, the client device 220 may transmit application programming interface (API) calls to send queries to the model inferencing module 216. The T2I models deployed by the model inferencing module 216 may receive the queries and generate outputs (e.g., images) corresponding to the queries.

Additionally, the client device 220 may include at least one of a smartphone, a tablet, a laptop, a desktop computer, a wearable device, or any other computing device capable of executing an application. The electronic device 202 may act as a backend server configured to host the application and provide services to the client device 220.

The application executed on the client device 220 may transmit queries to the electronic device 202 via at least one of an API call, a Hypertext Transfer Protocol (HTTP) request, a WebSocket connection, or any combination thereof. The model inferencing module 216 deployed on the electronic device 202 may receive the queries and generate outputs (e.g., images) corresponding to the queries. The outputs may be transmitted back to the client device 220 for display to a user.

Users may also send feedback (e.g., user inputs different from the first text prompt) related to the T2I model, which may be used as a metric to evaluate model performance. The aggregation of feedback may trigger a formal review of the currently deployed T2I model, wherein the T2I evaluation models may be deployed to perform additional measurements for further evaluation.

According to one or more embodiments, users may directly provide inputs to the electronic device 202 without the client device 220. The inputs may be provided via at least one of a keyboard, a mouse, a trackpad, a stylus, a microphone, or any combination thereof.

The electronic device 202 may include smartphones, tablets, desktop computers, laptop computers, workstations, E-readers, Televisions (e.g., Smart TV), gaming devices, streaming devices, smartwatches, home appliances (e.g., refrigerators, washing machines, dryers, dishwashers, air conditioners), drones, monitors, VR headsets, AR glasses, or any combination thereof.

Although the electronic device 202 is illustrated as a single device in FIG. 2, embodiments of the present disclosure are not limited thereto. For example, the electronic device 202 may comprise a backend server in a distributed computing environment, wherein various computing nodes may individually or collectively perform the functionality described herein. The backend server may host one or more applications that enable users to interact with the T2I models deployed thereon.

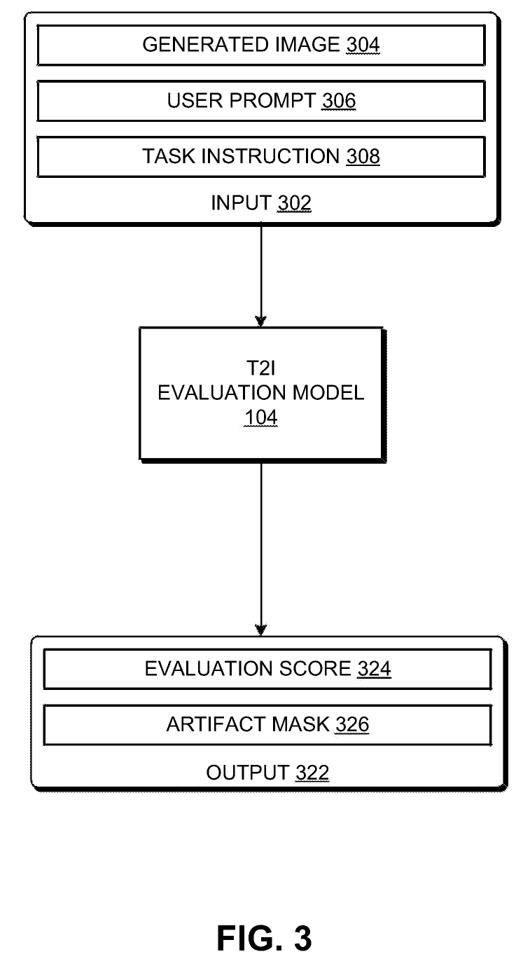

FIG. 3 is a diagram illustrating a T2I evaluation model, according to one or more embodiments of the present disclosure. System 300 may include T2I the evaluation model 104. The inputs 302 to the T2I evaluation model 104 may include generated image 304 from other T2I models, user prompt 306 used to generate the generated image 304, and task instruction 308. The task instruction 308 may include what type of scores that the T2I evaluation model 104 is going to generate. For example, task instruction 308 may include generating scores measuring image-text alignment, aesthetics, visual quality, etc. The task instruction 308 may further include generating artifact masks 326 indicating image regions that contain unnatural content.

According to one or more embodiments, the T2I evaluation model 104 may use inputs 302 to generate outputs 322 that include an evaluation score 324 and artifact mask 326. The artifact mask 326 may be highlighted in the generated image 304 as a separate color to indicate regions with unnatural content. The T2I evaluation model 104 may repeat the process of outputting different evaluations so that a training data set may be generated to further train T2I models (e.g., second pre-trained T2I model 106) to generate improved T2I models (e.g., improved T2I model 108). In order to generate the training data set, only the images that have corresponding scores that meet a criterion (e.g., an image with a score larger than X) may be included in the training data set. Consequently, the T2I evaluation model 104 may cover a wide variety of evaluation aspects such as image quality and unnatural image regions identification to better align with user preferences.

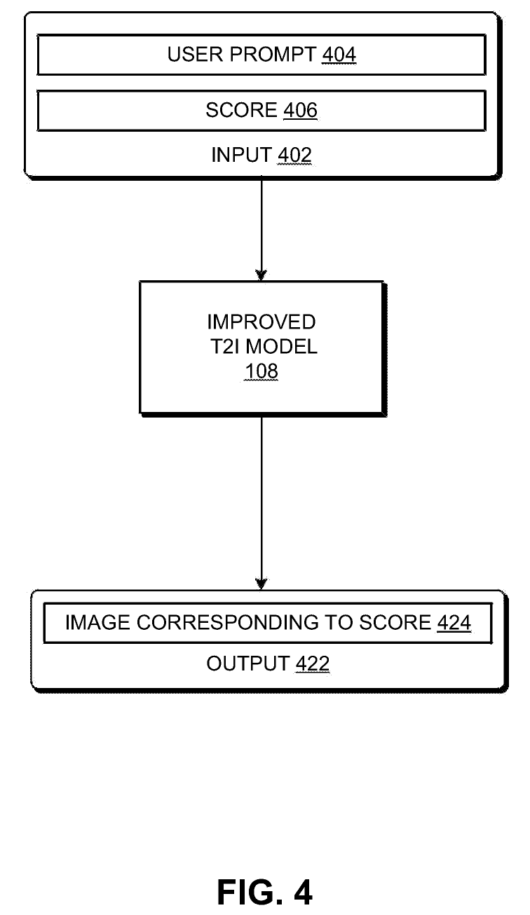

FIG. 4 is a diagram illustrating a T2I model improved based on evaluations generated by the T2I evaluation model, according to one or more embodiments of the present disclosure. System 400 may include improved T2I model 108. The inputs 402 to the improved T2I model 108 may include user prompt 404 and score 406. An example user prompt 404 may include “a woman walking on the street.” An example score 406 may include “the image quality is of 10.”

According to one or more embodiments, the improved T2I model 108 may use inputs 402 to generate outputs 422 that include an image corresponding to score 424. The image corresponding to score 424 may be further evaluated by the T2I evaluation model 104 to determine whether the T2I model 108 meets the criteria for deployment or is otherwise visible to users to perform T2I generation.

According to one or more embodiments, the improved T2I model 108 may generate outputs 422 that have high correlation with human preferences on all evaluation tasks, such as plausibility, aesthetics, text-image alignment, etc.

FIG. 5 is another diagram illustrating the T2I evaluation model 104, according to one or more embodiments of the present disclosure. The T2I evaluation model 104, during training or inferencing, may receive the user prompt 306, generated image 304, and task instruction 308 as inputs. The T2I evaluation model 104 may include a pre-trained portion 511, image encoder 512, mask decoder 514, and score decoder 515. The pre-trained portion 511 may refer to a pre-trained neural network architecture that has been trained on extensive textual datasets to acquire generalized natural language understanding and generation capabilities. The pre-trained neural network architecture may process and reason over multiple input modalities, including but not limited to text, images, audio, and video.

According to one or more embodiments, during training of the T2I evaluation model 104, fine-tuning may be performed on the pre-trained portion 511 so that the pre-trained portion 511 may generate special tokens such as first token 516 and second token 517. The first token 516 may correspond to the evaluation score 324 and the second token 517 may correspond to the artifact mask 326. The type of evaluation score 324 may include type at least one of text-image alignment score generation, aesthetic quality score generation, overall quality score generation, or plausibility score generation.

The T2I tokenizer vocabulary of the pre-trained portion 511 may be expanded by adding the special tokens. Expanding the tokenizer vocabulary may refer to augmenting this original vocabulary with additional specialized tokens so that the pre-trained portion 511 may generate two or more distinct types of tokens within a single output sequence. During fine-tuning of the pre-trained portion 511, the pre-trained portion 511 may learn the semantic meaning and appropriate generation patterns for the newly introduced tokens. The pre-trained portion 511 may take the user prompt 306 and the generated image 304 to generate an output sequence.

The pre-trained portion 511 may further extract the last-layer embedding feature h_{score} and h_{seg} based on the output sequence, where h_{score} and h_{seg} may correspond to the first token 516 and second token 517, respectively. As additional tokens can be added to the tokenizer vocabulary, the T2I evaluation model 104 may be trained to scale up additional score prediction tasks by continual learning on related training pairs, thereby adding flexibility in what the T2I evaluation model 104 can generate.

The mask decoder 514 and the score decoder 515 may refer to modality specific heads to predict evaluation scores and visual mask respectively. The score decoder 515 may be a neural network that receives the first tokens 516 and predict the evaluation score 324. For example, the score decoder 515 may perform Oₛ = F_{score} (h_{score}), where Oₛ may refer to target score and F_{score} may refer to a two-layer multi-layer perceptron. The score decoder 515 may be task agonistic and may be a shared score prediction decoder that predicts all types/aspects of metric scores. The task instruction 308 may indicate which type/aspect of the evaluation score 324 that the score decoder 515 needs to predict.

The mask decoder 514 may be a neural network that receives second tokens 517 and features extracted by an image encoder 512 to generate artifact masks 326. The image encoder 512 may refer to a model that processes raw image data and extracts high-dimensional feature representations capturing visual information such as objects, spatial relationships, textures, and semantic content present within the input image. The image encoder 512 may transform the input image into a sequence of feature vectors or a feature map that can be subsequently processed by downstream components of the T2I evaluation model 104. The image encoder 512 may include CNN (e.g., ResNet, EfficientNet, ViT, DINO, Segment Anything Model (SAM) encoder, among others.

According to one or more embodiments, the mask decoder 514 may include SAM decoder, Mask2Former decoder, detection transformer decoder, MaskDINO decoder, among others. The mask decoder 514 may receive dense visual features of generated image 304 extracted from the image encoder 512. The mask decoder 514 may include a MLP projection layer that transforms h_{seg} to h`_{seg} where h`_{seg} may refer to segmentation prompt embedding. The mask decoder 514 may perform O_{M} = F_{seg} (h`_{seg} , f), where O_{M} may refer to artifact masks 326, f may refer to the dense visual features, and F_{seg} may refer to a segmentation head.

For an end to end training of the T2I evaluation model 104, the pre-trained portion 511 may be fine-tuned and, the mask decoder 514 and the score decoder 515 may be fully trained. Fine-tuning may include low-rank adaptation (LoRA). LoRA may refer to a technique may refer to freezes the pretrained weight matrices of a neural network (e.g., pre-trained portion 511) and uses parallel trainable matrices that are decomposed into two low-rank factors, where the weight update is computed as the product of these factors. During forward propagation, inputs may be passed through both the frozen original weights and the low-rank decomposition, with the outputs summed together to produce the final result. However, one or more embodiments of the present disclosure are not limited and the pre-trained portion 511 may be fully trained.

There may be three different losses that correspond to each of the pre-trained portion 511, the mask decoder 514, and the score decoder 515. The first loss may include auto-regressive cross-entropy loss and be used for the pre-trained portion 511 to generate target text outputs with special tokens. The second loss may employ the mean squared error (MSE) loss between the score predictions and target values. The third loss may be a combination of per-pixel binary cross-entropy (BCE) loss and DICE loss. The total training loss may be formulated as a weighted some of the first loss, the second loss, and the third loss. For example, the total training loss of the T2I evaluation model may be ℒ = λtext * ℒtext + λscore * ℒscore + λseg * ℒ seg, where λtext, λscore, and λseg may refer to weights to each loss and ℒtext, ℒscore, ℒ seg may refer to the first loss, the second loss, and the third loss, respectively. However, one or more embodiments may not be limited and there can be a different combination of various loss functions such as MSE loss, mean absolute error (MAE) loss, Huber Loss, cross-entropy loss, focal loss, contrastive loss, intersection over union (IoU) loss, boundary loss, or any combination thereof.

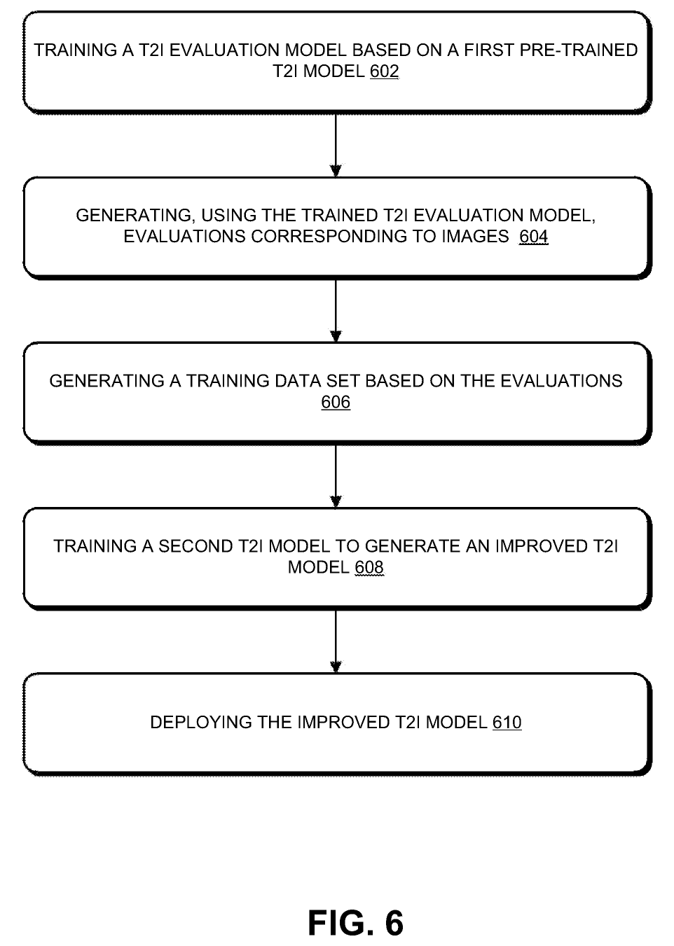

FIG. 6 is a flowchart illustrating process 600 for training the T2I evaluation model to improve T2I models, according to one or more embodiments of the present disclosure. According to one or more embodiments, one or more components of system 200, either individually or in combination, may perform one or more operations of the process 600. The one or more components of system 200 may include electronic device 202, processor 204, evaluation model training module 212, T2I model training module 214, model inferencing module 216, and client device 220. Also, one or more portions of the T2I evaluation model 104, either individually or in combination, may perform the one or more operations of the process 600. The one or more components of the T2I evaluation model 104 may include pre-trained portion 511, image encoder 512, mask decoder 514, and score decoder 515. Also, the improved T2I model 108 may perform the one or more operations of the process 600.

In the following embodiments, the one or more operations of the process 600 may be performed sequentially, in a different order, in parallel, or with some operations skipped or repeated.

According to at least one embodiment, operation 602 of process 600 may include training a T2I evaluation model (e.g., T2I evaluation model 104) based on a first pre-trained T2I model (e.g., first pre-trained T2I model 102).

According to at least one embodiment, operation 604 of process 600 may include generating, using the trained T2I evaluation model, evaluations (e.g., output 322, evaluation score 324, artifact mask 326) corresponding to images (e.g., input 302, generated image 304).

According to at least one embodiment, operation 606 of process 600 may include generating a training data set based on the evaluations. The training data may include reward instructions.

According to at least one embodiment, operation 608 of process 600 may include training a second T2I model (e.g., second pre-trained T2I model 106) to generate an improved T2I model (e.g., improved T2I model 108).

Operation 610 of process 600 may include deploying the improved T2I model 610. Process 600 may be repeated one or more times to improve accuracy and/or performance of various T2I models described herein.

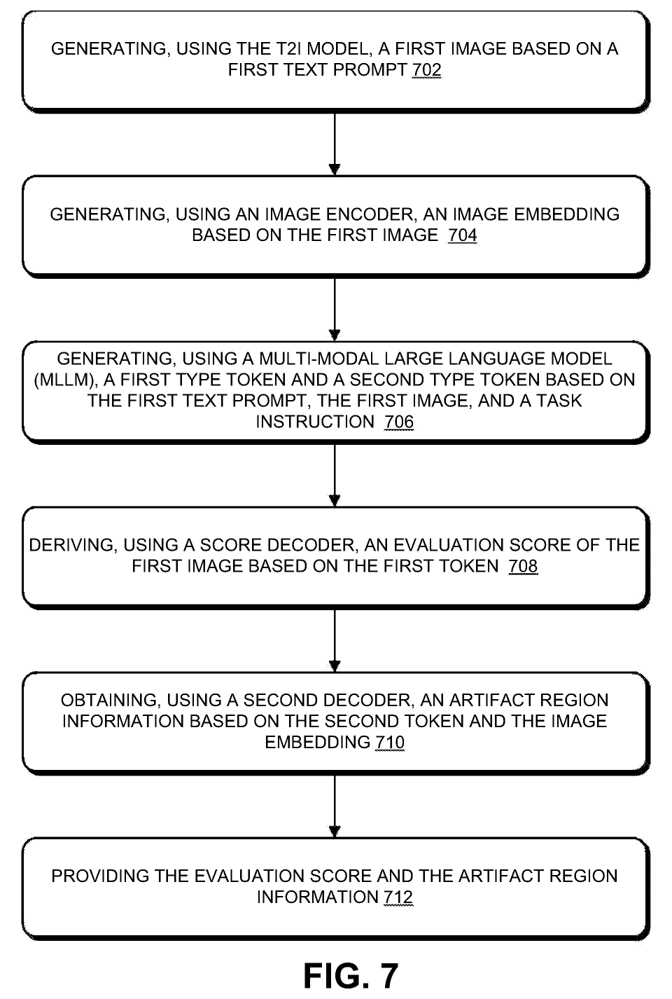

FIG. 7 is a flowchart illustrating process 700 for generating evaluations using the T2I evaluation model, according to one or more embodiments of the present disclosure. According to one or more embodiments, one or more components of system 200, either individually or in combination, may perform one or more operations of the process 700. The one or more components of system 200 may include electronic device 202, processor 204, evaluation model training module 212, T2I model training module 214, model inferencing module 216, and client device 220. Also, one or more portions of the T2I evaluation model 104, either individually or in combination, may perform the one or more operations of the process 700. The one or more components of the T2I evaluation model 104 may include pre-trained portion 511, image encoder 512, mask decoder 514, and score decoder 515. Also, the improved T2I model 108 may perform the one or more operations of the process 700.

In the following embodiments, the one or more operations of the process 700 may be performed sequentially, in a different order, in parallel, or with some operations skipped or repeated.

Operation 702 of process 700 may include generating, using the T2I model (e.g., second pre-trained T2I model), a first image based on a first text prompt.

Operation 704 of process 700 may include generating, using an image encoder (e.g., image encoder 512), an image embedding based on the first image. The image embedding may include various features of the first image.

Operation 706 of process 700 may include generating, using an MLLM, a first type token (e.g., first tokens 516) and a second type token (e.g., second tokens 517) based on the first text prompt (e.g., user prompt 306), the first image (e.g., generated image 304), and a task instruction (task instruction 308).

Operation 708 of process 700 may include deriving, using a first decoder (e.g., score decoder 515), an evaluation score (e.g., evaluation score 324) of the first image based on the first token. The evaluation score may be of various types and the type may be based on the task instruction that the MLLM receives.

Operation 710 of process 700 may include obtaining, using a second decoder (e.g., mask decoder 514), an artifact region information (e.g., artifact mask 326) based on the second token and the image embedding.

Operation 712 of process 700 may include providing the evaluation score and the artifact region information. One or more operations of process 700 may be repeated one or more times to generate a data set to train any T2I models described herein.

The provided evaluation score and the artifact region information may be used to generate reward instructions to fine-tune the T2I model. For example, T2I model may be fine-tuned based on the generated reward instruction, text prompt used to generate a corresponding output image, and the output image.

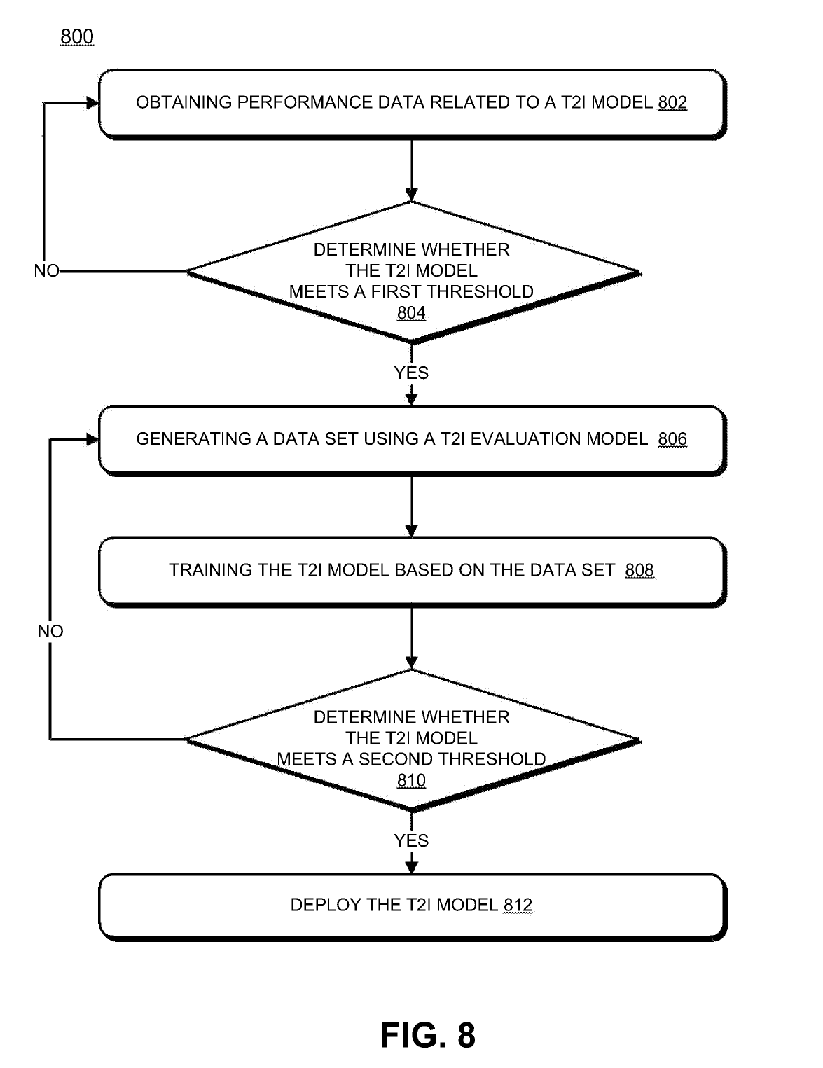

FIG. 8 is a flowchart illustrating process 800 for evaluating and fine-tuning T2I models using T2I evaluation models, according to one or more embodiments of the present disclosure. According to one or more embodiments, one or more components of system 200, either individually or in combination, may perform one or more operations of the process 800. The one or more components of system 200 may include electronic device 202, processor 204, evaluation model training module 212, T2I model training module 214, model inferencing module 216, and client device 220. Also, one or more portions of the T2I evaluation model 104, either individually or in combination, may perform the one or more operations of the process 800. The one or more components of the T2I evaluation model 104 may include pre-trained portion 511, image encoder 512, mask decoder 514, and score decoder 515. Also, the improved T2I model 108 may perform the one or more operations of the process 800.

In the following embodiments, the one or more operations of the process 800 may be performed sequentially, in a different order, in parallel, or with some operations skipped or repeated.

Operation 802 of process 800 may include obtaining performance data related to a T2I model (e.g., second pre-trained T2I model 106). The performance data may be obtained based on user feedback. The performance data may be based on running the T2I evaluation model. In some examples, the performance data may be based on running the T2I evaluation model multiple times so that the model provides various scores for various images. Also, the performance data may be based on the artifacts indicated by the masks generated by the T2I evaluation model. The performance data may be also based on a weighted sum of different scores and the number of artifacts detected within the images that the T2I models generate.

Operation 804 of process 800 may include determining whether the T2I model meets a first threshold. Meeting a threshold, as used herein, may include satisfying a condition relative to a value, such as exceeding the value, reaching the value exactly, or falling below the value. The threshold value may be static (e.g., preset or preconfigured) or dynamic (e.g., determined at runtime based on one or more parameters). If the T2I model meets the first threshold (“Yes”), operation 806 may be performed. Otherwise (“No”), operation 802 may be performed. The value may include a weighted sum of different types of quality scores that the images generated by the T2I models received.

Operation 806 of process 800 may include generating a data set using a T2I evaluation model (e.g., T2I evaluation model 104). The generated data set may include reward signals described herein.

Operation 808 of process 800 may include training the T2I model based on the data set. The scores within the reward signals may be used so that high-scoring images shape the model more strongly. For example, when computing a denoising loss to fine-tune the T2I models, the scores may serve as weights to the loss such that images with higher scores may highly contribute to adjusting the parameters of the T2I models.

Also, the scores within the reward signals may be used so that the improved T2I model may receive the scores, prompt, and the generated data as inputs and generate images that correspond to the scores. The loss may increase if the T2I model generates images that deviate from the quality of the score as received as inputs.

The artifact masks (e.g., artifact mask 326) that indicate the artifacts within the reward signals may be used to train the T2I model such that the improved T2I model does not generate those artifacts when generating the image with the same prompt. The losses may be tuned so that the improved T2I model does not generate artifacts. For example, the losses for mask regions may be different for the losses for other regions when computing the total loss for fine tuning the T2I model. The losses corresponding to the mask regions may be zeroed out or the losses for the mask regions may be inverted or become an adversarial loss.

Operation 810 of process 800 may include determining whether the improved T2I model meets a second threshold. The second threshold may be different from the first threshold. Measuring the performance if the T2I may be done using the T2I evaluation model. To measure the performance of the improved T2I model, the improved T2I model may be tested or deployed in one or more operational environments, wherein the improved T2I model receives input text prompts and generates corresponding images that are evaluated based on predefined criteria. If the improved T2I model meets the second threshold (“Yes”), operation 812 may be performed. Otherwise, operation 806 may be performed to repeat the operations to further improve the T2I model.

Operation 812 of process 800 may include deploying the T2I model 812 such that users may submit prompts to the T2I model through an API or application executing on one or more electronic devices, causing the T2I model to generate images with enhanced accuracy.

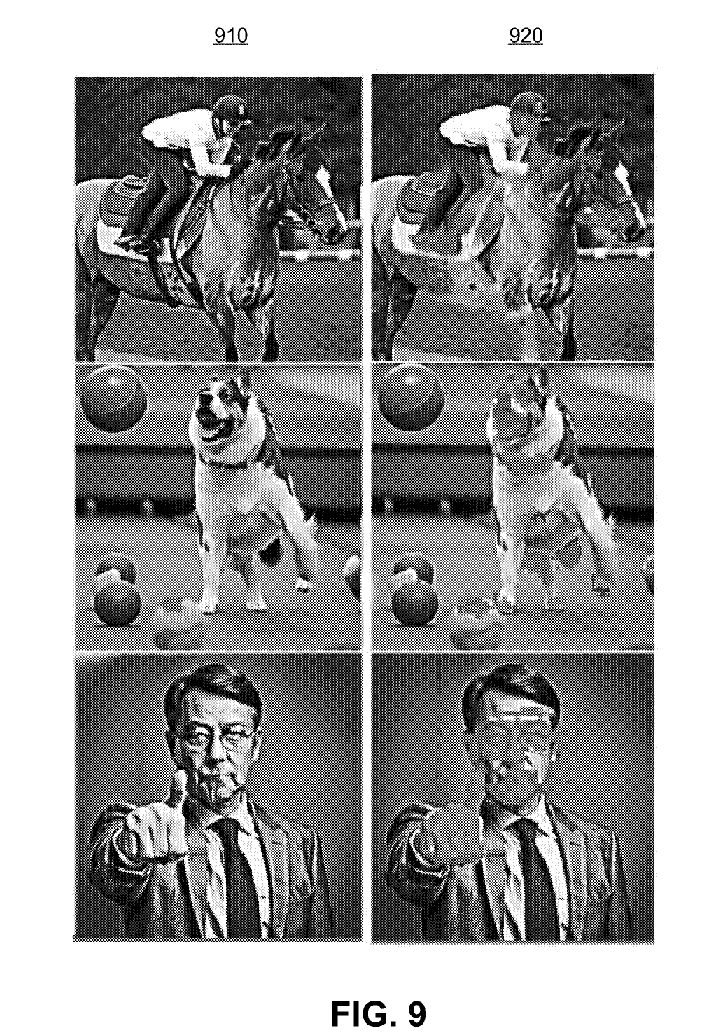

FIG. 9 illustrates examples of images with and without masks that indicate artificat regions, according to one or more embodiments of the present disclosure. A first set of examples 910 may include images (e.g., generated image 304) generated by the T2I models (e.g., second pre-trained T2I model 106) based on text (e.g., user prompt 306), where the T2I models may need further training to increase the accuracy. The first set of examples 910 may include artifacts within the image that are indicative of one or more image generation errors. The artifacts may include at least one of distorted features, unnatural textures, blurred regions, missing or duplicated elements, inconsistent lighting, color artifacts, pixelation, anatomical inaccuracies, spatial inconsistencies, or any combination thereof.

A second set of examples may include images (e.g., output 322) that include masks (e.g., artifact mask 326) indicating regions corresponding to the artifacts. The masks may serve as training data for training the models. By training on the masks, the T2I models may learn to identify and reduce artifacts, resulting in generated images with improved quality and fewer visual imperfections.

The artifact masks may be used to fine-tune various T2I models to generate improved T2I models (e.g., improved T2I model 108). For example, during fine-tuning of the T2I models, loss that correspond to the pixels that are indicated by the artifact masks may be changed or weighted differently so that parameters of the T2I models are updated to avoid generating such artifacts within the image. The loss can be zeroed out or may be inversed depending on the fine-tuning technique. The artifact masks may be used to teach the T2I models to attend or not attend the pixels or regions indicated by the artifact masks.

The terms “a,” “an,” “the,” and similar referents in the context of describing the disclosed embodiments (especially in the claims) are to be construed to cover both singular and plural forms, unless otherwise indicated or clearly contradicted by context. The number of items in a plurality is at least two, but may be more when indicated explicitly or by context.

When an element or layer is referred to as being “on,” “connected to,” or “coupled to” another element or layer, it can be directly on, connected, or coupled to that element or layer, or intervening elements or layers may be present. By contrast, when an element is referred to as being “directly on,” “directly connected to,” or “directly coupled to” another element or layer, no intervening elements or layers are present.

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features, numbers, steps, operations, elements, components, or combinations thereof.

Recitation of ranges of values herein is merely intended to serve as a shorthand method of referring individually to each separate value falling within the range, unless otherwise indicated. Each separate value is incorporated into the specification as if it were individually recited herein.

Terms such as “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

As used herein, an expression, “a and/or b” should be understood as including only a, only b and both a and b. As used herein, expressions “at least one of a, b, and c” and “at least one of a, b, or c” should be understood as including only a, only b, only c, both a and b, both a and c, both b and c, or all of a, b, and c.

Further, unless stated otherwise or otherwise clear from context, phrase “based on” may refer to “based at least in part on” and not “based solely on.”

The terms “first,” “second,” “third,” and the like in the description and in the claims, if any, are used for distinguishing between similar elements and not necessarily for describing a sequential or chronological order. It is to be understood that the terms so used are interchangeable under appropriate circumstances.

Unless explicitly described or implicitly understood from one or more embodiments of the present disclosure, at least one of the components, elements, modules, units, or nominalized verbs represented by a block or equivalent indication in the drawings may be implemented or embodied by analog and/or digital circuits. These circuits may include one or more of a logic gate, an integrated circuit, a microprocessor, a microcontroller, a memory circuit, a passive electronic component, an active electronic component, an optical component, and the like. Alternatively or additionally, these components may be implemented or embodied by software comprising one or more instructions stored in an internal or external storage medium that is readable by at least one processor. For example, the at least one processor may invoke at least one of the one or more instructions stored in the storage medium and execute it, with or without using one or more other components under the control of the at least one processor. This allows the at least one processor to perform at least one function or operation described above as being performed by each of the components according to the at least one instruction invoked. The at least one processor may include a central processing unit (CPU), a graphics processing unit (GPU), or another type of microprocessor, without limitation. In other examples, the at least one processor may be implemented as an application-specific integrated circuit (ASIC) or field-programmable gate array (FPGA).

In accordance with an embodiment, a non-transitory computer-readable or machine-readable storage medium may store program instructions that, when executed by at least one processor (e.g., processor 204), cause the at least one processor or an electronic device (e.g., electronic device 202, client device 220) to perform one or more of the operations described herein.

What is claimed is:

1. A method for evaluating images generated by a Text-to-Image (T2I) model, the method comprising:
generating, using the T2I model, a first image based on a first text prompt;
generating, using an encoder, an image embedding based on the first image;
generating, using a Multi-Modal Large Language Model (MLLM), a first type token and a second type token based on the first text prompt, the first image, and a task instruction;
deriving, using a first decoder, an evaluation score of the first image based on the first type token;
obtaining, using a second decoder, an artifact region information based on the second type token and the image embedding; and
providing the evaluation score and the artifact region information.

2. The method of claim 1, further comprising:
generating a reward instruction based on the evaluation score and the artifact region information; and
fine-tuning the T2I model based on the reward instruction, the first text prompt, and the first image,
wherein at least one loss function to fine-tune the T2I model is adjusted based on at least one of the evaluation score or the artifact region information.

3. The method of claim 2, wherein the fine-tuning of the T2I model is performed based on a determination that the T2I model met one or more criteria corresponding to an accuracy of the T2I model, and
wherein the determination is based on at least one of user input different from the first text prompt, the evaluation score, or the artifact region information.

4. The method of claim 2, further comprising:
generating, using the fine-tuned T2I model, a second image based on a second text prompt and a score that correspond to the second image.

5. The method of claim 4, wherein the second image includes a plurality of pixels replaced in areas identified as artifacts by the artifact region information.

6. The method of claim 1, wherein the MLLM is fine-tuned based on Low-Rank Adaptation (LoRA).

7. The method of claim 1, wherein the task instruction indicates a type of the evaluation score to be generated.

8. The method of claim 7, wherein the type of the evaluation score includes at least one of text-image alignment score generation, aesthetic quality score generation, overall quality score generation, or plausibility score generation.

9. The method of claim 1, wherein the artifact region information is indicated by one or more binary masks.

10. The method of claim 1, wherein the MLLM, the first decoder, and the second decoder are trained based on at least one of of auto-regressive cross-entropy loss, mean squared error (MSE) loss, binary cross-entropy (BCE) loss, or DICE loss.

11. An electronic device comprising:
at least one processor; and
memory storing at least one instruction,
wherein the at least one instruction, when executed by the at least one processor individually or collectively, cause the electronic device to:
generate, using the T2I model, a first image based on a first text prompt;
generate, using an encoder, an image embedding based on the first image;
generate, using a Multi-Modal Large Language Model (MLLM), a first type token and a second type token based on the first text prompt, the first image, and a task instruction;
derive, using a first decoder, an evaluation score of the first image based on the first type token;
obtain, using a second decoder, an artifact region information based on the second type token and the image embedding; and
provide the evaluation score and the artifact region information.

12. The electronic device of claim 11, wherein the at least one instruction, when executed by the at least one processor individually or collectively, further cause the electronic device to:
generate a reward instruction based on the evaluation score and the artifact region information; and
fine-tune the T2I model based on the reward instruction, the first text prompt, and the first image,
wherein at least one loss function to fine-tune the T2I model is adjusted based on at least one of the evaluation score or the artifact region.

13. The electronic device of claim 12, wherein the at least one instruction, when executed by the at least one processor individually or collectively, further cause the electronic device to:
fine-tune of the T2I model is based on an determination that the T2I model met one or more criteria corresponding to an accuracy of the T2I model, and
wherein the determination is based on at least one of user input different from the first text prompt, the evaluation score, or the artifact region.

14. The electronic device of claim 12, wherein the at least one instruction, when executed by the at least one processor individually or collectively, further cause the electronic device to:
generate, using the fine-tuned T2I model, a second image based on a second text prompt and a score that correspond to the second image.

15. The electronic device of claim 14, wherein the second image includes a plurality of pixels replaced in areas identified as artifacts by the artifact region information.

16. The electronic device of claim 11, wherein the MLLM is fine-tuned based on Low-Rank Adaptation (LoRA).

17. The electronic device of claim 11, wherein the task instruction indicates a type of the evaluation score to be generated, and
wherein the type of the evaluation score includes at least one of text-image alignment score generation, aesthetic quality score generation, overall quality score generation, or plausibility score generation.

18. The electronic device of claim 11, wherein the artifact region information is indicated by one or more binary masks.

19. The electronic device of claim 11, wherein the MLLM, the first decoder, and the second decoder are trained based on at least one of auto-regressive cross-entropy loss, mean squared error (MSE) loss, binary cross-entropy (BCE) loss, or DICE loss.

20. A non-transitory computer-readable storage medium having stored thereon instructions that, when executed by at least one processor of an electronic device individually or collectively, cause the electronic device to:
generate, using the T2I model, a first image based on a first text prompt;
generate, using an encoder, an image embedding based on the first image;
generate, using a Multi-Modal Large Language Model (MLLM), a first type token and a second type token based on the first text prompt, the first image, and a task instruction;
derive, using a first decoder, an evaluation score of the first image based on the first type token;
obtain, using a second decoder, an artifact region information based on the second type token and the image embedding; and
provide the evaluation score and the artifact region information.
